(19) United States
(12) Patent Application Publication
(10) Pub. No.: US 2020/0033850 A1
(43) Pub. Date: Jan. 30, 2020

(54) METHOD, APPARATUS, AND MONITORING DEVICE FOR PROCESSING SIGNALS OF UNMANNED AERIAL VEHICLE

(71) Applicant: SZ DJI TECHNOLOGY CO., LTD., Shenzhen (CN)

(72) Inventors: Puchang YANG, Shenzhen (CN); Renqin DENG, Shenzhen (CN); Mingguo YI, Shenzhen (CN)

(21) Appl. No.: 16/591,240

(22) Filed: Oct. 2, 2019

Related U.S. Application Data
(63) Continuation of application No. PCT/CN2017/079699, filed on Apr. 7, 2017.

(51) Int. Cl. G05D 1/00; B64C 39/02; H04W 4/80; H04B 7/185; H04L 29/06

(52) U.S. Cl. CPC G05D 1/0022; B64C 39/024; B64C 2201/122; H04B 7/18504; H04L 29/06; H04W 4/80

(57) ABSTRACT

The present disclosure provides an UAV signal processing method. The method includes receiving a plurality of signals including monitored information of the UAV transmitted by the UAV; and, parsing, by a plurality of communication protocol parsing devices, the received signals to obtain a plurality of parsing results, wherein one or more of the parsing results include the monitored information of the UAV.

### CROSS-REFERENCE TO RELATED APPLICATION

This application is a continuation application of International Application No. PCT/CN2017/079699, filed on Apr. 7, 2017, the entire contents of which are incorporated herein by reference.

### TECHNICAL FIELD

The present disclosure relates to the field of Unmanned Aerial Vehicle (UAV) technology, more specifically, to a method, apparatus, and monitoring device for processing signals of an UAV.

### BACKGROUND

With the continuous advancement in science and technology, the functions of UAVs have continued to grow, and its field of applications have also expanded to include professional aerial photography, agricultural irrigation, electric power cruise, remote sensing and mapping, security monitoring, etc. Although UAVs have brought convenience into people's lives, UAVs also pose a potential threat to the security of certain businesses. For example, a UAV flying into a military zone may lead to a leak of military information; and a UAV flying into an airport may cause accidents. Therefore, a certain degree of regulation and monitoring of the UAVs is needed.

In order to prevent the UAV from flying into a no-fly zone, a monitoring device is usually used to monitor the signals of the UAV. More specifically, the UAV may transmit signals including monitored information (e.g., location information of the UAV, serial number of the UAV, position information of a control terminal of the UAV) to a control terminal of the UAV through a downlink data link. The monitoring device receives and parses the signals including the monitored information transmitted through the downlink data link to obtain the monitored information of the UAV in the signals. However, different types of UAVs and their control terminals may use different communication protocols while performing data exchange. For example, some types of UAVs may use the Wi-Fi protocol, and some types of UAVs may use a Software Defined Radio (SDR) protocol. Further, before the UAV is monitored, the communication protocol used by the monitored UAV and its control terminal to perform the data exchange may be unknown. Therefore, the monitoring device needs to be able to use different communication protocols to monitor different types of UAVs.

### SUMMARY

The embodiments of the present disclosure provide a method, apparatus, and monitoring device for processing signals of an UAV. Even if the communication protocol used by the UAV to transmit the signals including the monitored information is unknown, the signals may still be parsed to obtain the monitored information of the UAV in the signals.

One aspect of the present disclosure provides an UAV signal processing method. The method includes receiving a plurality of signals including monitored information of the UAV transmitted by the UAV; and, parsing, by a plurality of communication protocol parsing devices, the received signals to obtain a plurality of parsing results, wherein one or more of the parsing results include the monitored information of the UAV.

Another aspect of the present disclosure provides a signal processing device of an UAV. The signal processing device includes an antenna configured to receive a plurality of signals including monitored information of the UAV transmitted by the UAV; and a plurality of communication protocol parsing devices configured to parse the signals received by the antenna to obtain a plurality of parsing results, wherein one or more of the parsing results of the communication protocol parsing devices include the monitored information of the UAV.

The embodiments of the present disclosure provide a method, apparatus, and monitoring device for processing signals of an UAV. In particular, the signal processing device may receive the signals including the monitored information transmitted by the UAV. Further, the signal processing device may include a plurality of communication protocol parsing devices, and each type of communication protocol parsing device may parse the signals in the corresponding communication protocol. In particular, one or more communication protocol parsing devices may parse the signals to obtain the parsing results including the monitored information of the UAV. Therefore, by using the signal processing method and apparatus of the present disclosure, even if the communication protocol used by the UAV to transmit the signals including the monitored information is unknown, the signals transmitted by the UAV including the monitored information of the UAV may still be parsed to obtain the monitored information of the UAV transmitted by the UAV. Embodiments of the present disclosure improve the parsing capabilities of the signals including the monitored information transmitted by the UAV.

### BRIEF DESCRIPTION OF THE DRAWINGS

To describe the technical solutions in the embodiments of the present invention more clearly, the following briefly introduces the accompanying drawings needed to describe the embodiments of the present disclosure. The accompanying drawings in the following description show merely some embodiments of the present disclosure, and a person of ordinary skill in the art may still derive other drawings from these accompanying drawings without creative efforts.

FIG. 1 is a schematic diagram of a system architecture of a UAV monitoring system according to an embodiment of the present disclosure;

FIG. 2 to FIG. 10 are schematic diagrams illustrating the structure of a signal processing apparatus for a UAV according to an embodiment of the present disclosure; and,

FIG. 11 is a schematic flowchart of a signal processing method of a UAV according to an embodiment of the present disclosure.

### DETAILED DESCRIPTION OF THE EMBODIMENTS

To make the objectives, technical solutions, and advantages of the present disclosure clearer, the technical solutions of the embodiments of the present disclosure will be described below with reference to the accompanying drawings.

The embodiments of the present disclosure provide a method, apparatus, and monitoring device for processing signals of an UAV. Even if the communication protocol used by the UAV to transmit the signals including the monitored information is unknown, the signals may still be parsed to obtain the monitored information of the UAV in the signals.

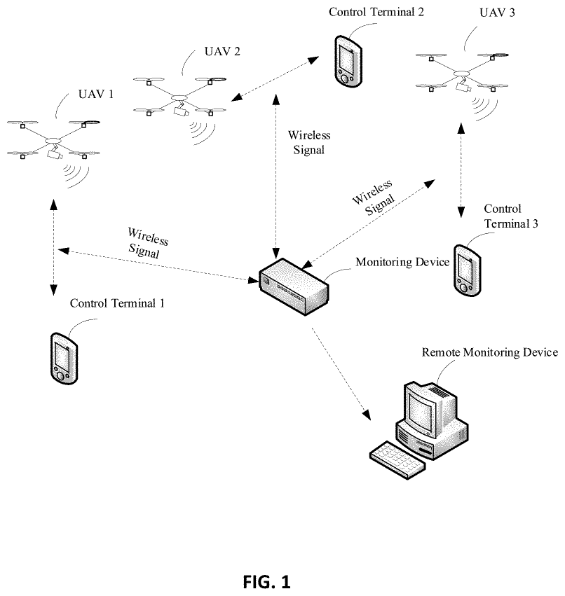

In order to clearly describe the technical solutions of the embodiments of the present disclosure, the use case and system architecture that may be applied to the embodiments of the present disclosure are described below with reference to FIG. 1.

FIG. 1 is a schematic diagram of a system architecture of a UAV monitoring system according to an embodiment of the present disclosure. The system in the present embodiment of the present disclosure includes one or more UAVs (as an example, the UAVs in FIG. 1 include UAV 1, UAV 2, and UAV 3), a monitoring device, and a remote monitoring device.

In some embodiments, the system may further include a control terminal for controlling the UAV, and a user may control the UAV by using the control terminal. The control terminal may be a smart phone, a laptop, a tablet, a remote control, a wearable device (e.g., a watch or a bracelet), or the like, or a combination thereof. The control terminal and the UAV may use a wireless data link to exchange data. In particular, the wireless data link may include an uplink data link and a downlink data link. The uplink data link may be used for transmitting data transmitted by the control terminal to the UAV, and the downlink data link may be used for transmitting data transmitted by the UAV to the control terminal. During the flight, the UAV may use the downlink data link to transmit signals including the monitored information to the control terminal. The monitoring device may include a signal process device, and the signal processing device may monitor the downlink data link, receive the signals including the monitored information transmitted by the UAV, and parse the signals to obtain the monitored information in the signals. The monitored information may be used to identify the current location of the UAV, the location information of the control terminal connected to the UAV, etc. to effectively monitor the UAV.

Further, the monitoring device may transmit the monitored information parsed by the signal processing device to the remote monitoring device by wire or wirelessly (e.g., 4G, 5G, low frequency private network, or Ethernet), and the remote monitoring device may display the monitored information on an interactive interface. In addition, if additional information of the UAV is needed, the remote monitoring device may transmit the monitored information or a portion of the monitored information to a server after obtaining the monitored information. The server may query the additional information of the UAV based on the signals transmitted by the remote monitoring device, and transmit the additional information of the UAV to the remote monitoring device. Furthermore, the remote monitoring device may display the additional information of the UAV on the interactive interface of the remote monitoring device.

In some embodiments, the monitoring device may support a variety of power modes such as utility power and battery. In addition, the monitoring device may also support pole, wall, or floor installation.

It should be understood that the use case and system architecture described in the embodiments of the present disclosure are for the purpose of more clearly illustrating the technical solutions of the embodiments of the present disclosure, and do not constitute a limitation on the technical solutions provided by the embodiments of the present disclosure. A person skilled in the art may realize that as the system architecture evolves and new use cases occur, the technical solutions provided by the embodiments of the present disclosure are capable to address similar technical problems.

The signal processing device provided in the embodiments of the present disclosure is further described below.

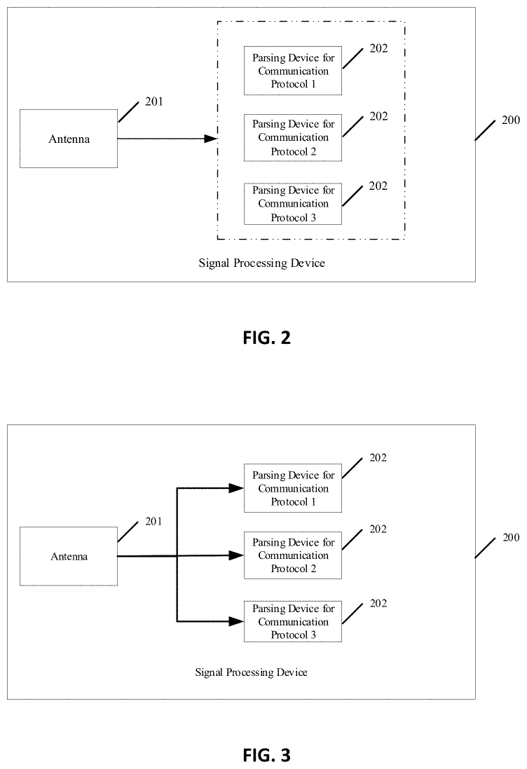

Referring to FIG. 2, FIG. 2 is a schematic structural diagram of a signal processing device of a UAV according to an embodiment of the present disclosure. In particular, the signal processing device may be a part of the monitoring device of the UAV. As shown in FIG. 2, the signal processing device 200 may include an antenna 201 and a plurality of communication protocol parsing devices 202. It is worth mentioning that the signal processing device 200 of the present disclosure may include two or more communication protocol parsing devices. In particular, the signal processing device in FIG. 2 includes three types of communication protocol parsing devices as an example.

The antenna 201 may be used to receive the signals including the monitored information transmitted by the UAV.

The communication protocol parsing devices 202 may be used to parse the signals received by the antenna 201 to obtain a plurality of parsing results, where the parsing results of one or more communication protocol parsing devices 202 from the plurality of communication protocol parsing devices 202 may include the monitored information of the UAV.

During the flight, the UAV may transmit the signals including the monitored information through a downlink data link, and the signal processing device 200 may monitor the downlink data link of the UAV. More specifically, the antenna 201 of the signal processing device 200 may receive signals including the monitored information transmitted by one or more UAVs.

In some embodiments, the monitored information of the UAV may include one or more of the following information: the location information of the UAV, the location information of the control terminal connected to the UAV, the ID number of the UAV, the takeoff location information of the UAV, and the flight speed of the UAV. Further, the monitoring device may determine whether the UAV may fly into the no-fly zone based on the monitored information of the UAV.

In some embodiments, the various communication protocols mentioned above may be determined from an Ultra-Wide Band (UWB), Wi-Fi, Bluetooth, SDR, 802.11, Zigbee, and customized communication protocols. In particular, the customized communication protocol may include a Lightbridge (LB) protocol.

For the different types of communication protocols, the specific way in which the UAV may transmit the signals including the monitored information on the UAV may be different, and a brief description is provided below:

In some embodiments, when the UAV and the control terminal use the Wi-Fi protocol to perform data exchange, the UAV may insert the monitored information into a Beacon signal, a Probe Request signal, or a Probe Response signal. At this point, the signal including the monitored information received by the antenna 201 may be the Beacon signal, the Probe Request signal, or the Probe Response signal.

In some embodiments, when the UAV and the control terminal use the SDR to perform data exchange, the UAV may configure the monitored information into a monitored subframe based on the SDR protocol, establish a time slice in the downlink data link, and transmit the monitored subframe in the time slice. Alternatively, the UAV may transmit the monitored subframe using one or more predetermined frequency points. At this time, the signals including the monitored information of the UAV received by the antenna 201 may be the monitored subframe.

In some embodiments, when the UAV and the control terminal use certain communication protocols to perform data exchange, the UAV may insert the monitored information into a downlink radio subframe including a work data of the UAV. The downlink radio subframe may be transmitted in the downlink data link and the monitored information may be inserted into a specific field in the downlink radio subframe. The specific field may be a channel control field, and the work data may include at least an image data acquired by an image acquisition device on the UAV. At this point, the signals including the monitored information of the UAV received by the antenna 201 may be the downlink radio subframe.

In the embodiments of the present disclosure, each type of communication protocol parsing device 202 may using a parsing rule corresponding to the communication protocol to parse the signals including the monitored information of the UAV transmitted by the UAV. That is, a communication protocol parsing device 202 may only parse the signals transmitted by the UAV using the communication protocol.

For example, the signal processing device 200 may include an SDR protocol parsing device 202, a Wi-Fi protocol parsing device 202, and a LB protocol parsing device 202. When the antenna 201 receives a signal including the monitored information transmitted by the UAV, the signal processing device 200 may not know the communication protocol the UAV used to transmit the signal including the monitored information. After the signal processing device 200 receives the signal, the signal processing device 200 may parse the signal using the SDR protocol parsing device 202, the Wi-Fi protocol parsing device 202, and the LB protocol parsing device 202. The SDR protocol parsing device 202 may parse the signal using a parsing rule corresponding to the SDR protocol. Similarly, the Wi-Fi protocol parsing device 202 may parse the signal using a parsing rule corresponding to the Wi-Fi protocol and the LB protocol parsing device 202 may parse the signal using a parsing rule corresponding to the LB protocol. Further, if the UAV transmitted the signal including the monitored information by using the SDR protocol, the SDR protocol parsing device 202 may successfully parse the signal, and the parsing results of the SDR protocol parsing device 202 may include the monitored information of the UAV.

In addition, when the antenna 201 of the signal processing device 200 receives signals transmitted by a plurality of UAVs, for example, the antenna 201 may receive signals including the monitored information of UAV 1 transmitted using the SDR protocol by the UAV 1, signals including the monitored information of UAV 2 transmitted using the Wi-Fi protocol by the UAV 2, and signals including the monitored information of UAV 3 transmitted using the LB protocol by the UAV 3. The signal processing device 200 may not know the communication protocols used by the UAV 1, UAV 2, and UAV 3 to transmit the signals including the monitored information. The antenna 201 of the signal processing device 200 may receive the signals including the monitored information of the UAV 1, UAV 2, and UAV 3, then use the communication protocol parsing devices 202 to parse the signals including the monitored information to obtain the parsing results. More specifically, the SDR protocol parsing device 202 may use the parsing rule corresponding to the SDR protocol to parse the signals transmitted by the UAV 1, UAV 2, and UAV 3, and the SDR protocol parsing device 202 may only parse the signals including the monitored information of UAV 1 transmitted by the UAV 1. Similar, the Wi-Fi protocol parsing device 202 may use the parsing rule corresponding to the Wi-Fi protocol to parse the signals transmitted by the UAV 1, UAV 2, and UAV 3, and the Wi-Fi protocol parsing device 202 may only parse the signals including the monitored information of UAV 2 transmitted by the UAV 2. Further, the LB protocol parsing device 202 may use the parsing rule corresponding to the LB protocol to parse the signals transmitted by the UAV 1, UAV 2, and UAV 3, and the LB protocol parsing device 202 may only parse the signals including the monitored information of UAV 3 transmitted by the UAV 3.

It can be seen that by using the signal processing device 200 provided by the present disclosure, the signal processing device may include a plurality of communication protocol parsing devices 202, and each type of communication protocol parsing device 202 may parse the signals of the corresponding communication protocol. Therefore, by using the embodiments of the present disclosure, even if the signal processing device is uncertain of the communication protocol used by the UAV to transmit the signals including the monitored information, the signal processing device may still parse the signals including the monitored information transmitted by the UAV to obtain the monitored information of the UAV transmitted by the UAV, thereby improving the parsing capabilities of the signals including the monitored information transmitted by the UAV.

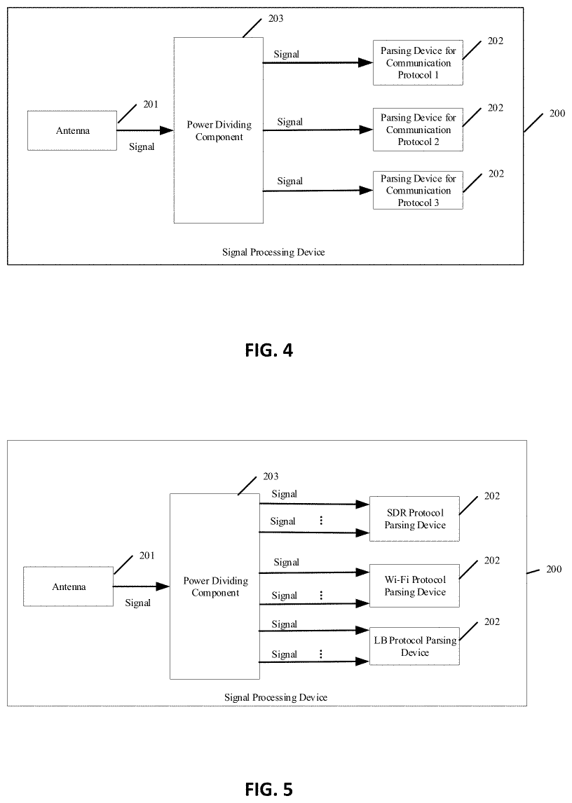

In some embodiments, as shown in FIG. 3, when the antenna of the signal processing device 200 receives the signals including the monitored information, the signals may be divided into multiple channels, and the signals in the multiple channels may be transmitted to communication protocol parsing devices to parse the signals in parallel. More specifically, as shown in FIG. 4, the signal processing device may further include a power dividing component 203, and the antenna 201 may be connected to the communication protocol parsing devices 202 through the power dividing component 203. Further, the power dividing component 203 may be used to divide the signals received by the antenna 201 into multiple channels after the antenna 201 receives the signals including the monitored information of the UAV transmitted by the UAV. As shown in FIG. 4, the power dividing component 203 may transmit the signals in the multiple channels to the communication protocol parsing devices 202. Correspondingly, the communication protocol parsing devices 202 may specifically be used to parse the signals in the multiple channels by using the communication protocol parsing devices 202 to obtain the parsing result.

In particular, the power dividing component 203 may be a circuit or a device that splits one power signal into multiple identical signals. For example, the power dividing component 203 may be a power divider.

That is, in the present embodiment, the communication protocol parsing device 202 may parse the signals received by the antenna 201 in parallel to obtain the parsing results. It can be seen that by implementing the present embodiment, the communication protocol parsing devices may simultaneously parse the signals, thereby increasing the signal parsing speed.

In some embodiments, after the antenna 201 receives the signals including the monitored information transmitted by the UAV, the signals may be serially transmitted to different communication protocol parsing devices 202, that is, the signals are transmitted to different parsing devices 202 in different time. For example, the signal processing device 200 may transmit the signals received by the antenna to the SDR protocol parsing device first based on a predetermined order. If the SDR protocol parsing device 202 can successfully parse the signals, the signal processing device 200 may stop transmitting the signals to the other communication protocol parsing devices 202. Further, if the SDR protocol parsing device cannot successfully parse the signals, the signal processing device may transmit the signals to the Wi-Fi protocol parsing device 202. If the Wi-Fi protocol parsing device 202 can successfully parse the signals, the signal processing device 200 may stop transmitting the signals to the other communication protocol parsing devices 202. Furthermore, if the Wi-Fi protocol parsing device cannot successfully parse the signals, the signal processing device may transmit the signals to the LB protocol parsing device 202. It can be seen that in this embodiment, it is not necessary to divide the signals received by the antenna into multiple channels, which may reduce the problem that may arise by the power division of the signals.

In some embodiments, each type of the communication protocol parsing device 202 in the plurality of communication protocol parsing devices 202 may specifically be used to parse the signals in a predetermined number of channels of the signals in the multiple channels. Further, the predetermined number of channels corresponding to each type of communication protocol parsing device 202 may be the same or different.

For example, as shown in FIG. 5, the power dividing component 203 may divide the signals received by the antenna 201 into 16 channels. In particular, the SDR protocol parsing device 202 may parse the signals in 4 of the 16 channels, the Wi-Fi protocol parsing device 202 may parse the signals in 6 of the 16 channels, and the LB protocol parsing device 202 may parse the signals in 6 of the 16 channels.

By implementing the present embodiment, each type of communication protocol parsing device may parse the signals in the predetermined number of channels of the signals in the multiple channels to obtain the parsing results, thereby improving the signal parsing speed.

In some embodiments, each of the communication protocol parsing device 202 in the plurality of communication protocol parsing devices 202 may include a predetermined number of parsing devices 202, which may be specifically used to parse the signals in the predetermined number of channels of the signals in the multiple channels. Further, the predetermined number of parsing devices corresponding to each type of communication protocol may be the same or different.

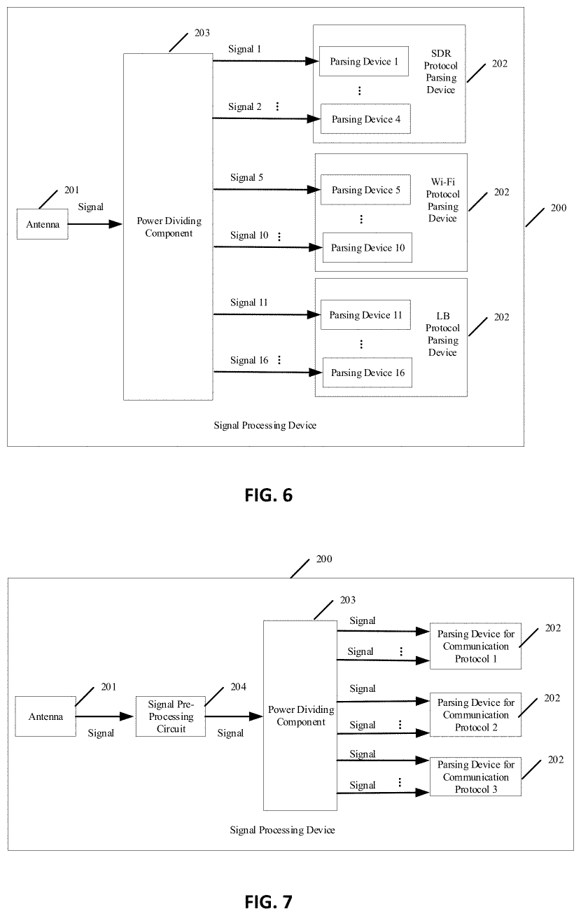

For example, as shown in FIG. 6, the SDR protocol parsing device 202 may include 4 parsing devices; the Wi-Fi protocol parsing device 202 may include 6 parsing devices; and the LB protocol parsing device 202 may include 6 parsing devices. The power dividing component 203 may divide the signals received by the antenna 201 into the 16 channels. A parsing device may have a one-to-one correspondence with one channel, and the 4 SDR protocol parsing devices may respectively parse the channels of signals corresponding to them. That is, a parsing device may parse a channel of signals, and the 4 SDR protocol parsing devices may parse the signals in 4 of the 16 channels. Similarly, the 6 Wi-Fi protocol parsing devices may respectively parse the channels of signals corresponding to them, and the 6 Wi-Fi protocol parsing devices may parse the signals in 6 of the 16 channels. Further, the 6 LB protocol parsing devices may respectively parse the channels of signals corresponding to them, and the 6 LB protocol parsing devices may parse the signals in 6 of the 16 channels.

By implementing the present embodiment, a predetermined number of parsing devices of each type communication protocol parsing device may parse the signals received by the antenna in parallel to obtain the parsing results, thereby improving the signal parsing speed.

In some embodiments, the predetermined number of channels and/or communication protocol parsing devices may be determined based on one or more of the following information: the number of downlink channels of the downlink data link of the UAV, an expected signal acquisition time, and the number of frequency points used by the UAV to transmit the signals including the monitored information.

For example, in response to the signals satisfying a signal-to-noise ratio of a detection condition, the LB protocol parsing device 202 in the signal processing device 200 may need approximately 4 signals including the monitored information to perform an Automatic Gain Control (AGC), a frame header detection, and a synchronization. Therefore, in theory, the parsing device 202 may only need to stay 4*14 milliseconds (i.e., 56 milliseconds) per channel to determine whether the current channel has the signals transmitted using the LB protocol. In order to avoid the possibility of a false detection and certain synchronization failures in the case where the signal-to-noise ratio is not high, the parsing device 202 may spend 112 milliseconds per channel to determine whether the current channel has the signals transmitted using the LB protocol. For UAVs using the LB protocol, the 2.4G frequency band and the 5.8G frequency band may be used to transmit the signals of the UAVs, where the 2.4G frequency band may have 32 downlink channels and the 5.8G frequency band may have up to 29 downlink channels. In order to satisfy the signal acquisition time of 2 seconds (that is, the time to parse the downlink signals of the UAV of the LB protocol), the signals in the 2.4G frequency band may correspond to 3 parsing devices 202, and the signals in the 5.8G frequency band may also correspond to 3 parsing devices 202. That is, the LB protocol parsing device 202 may include 6 parsing devices, and each of the parsing devices may correspond to one channel of signals. Therefore, the 6 parsing devices of the LB protocol parsing device 202 may parse the signals with the predetermined number of 6 channels.

Further, among the 3 parsing devices 202 corresponding to the 2.4G frequency band, the first parsing device 202 may parse the signals of 10 channels, the second parsing device 202 may parse the signals of 10 channels, and the third parsing device 202 may parse the signals of 12 channels.

Similarly, among the 3 parsing devices 202 corresponding to the 5.8G frequency band, the first parsing device 202 may parse the signals of 10 channels, the second parsing device 202 may parse the signals of 10 channels, and the third parsing device 202 may parse the signals of 9 channels.

Furthermore, the 6 parsing devices 202 may parse in parallel. Therefore, the 6 parsing devices 202 may parse all the downlink channels in the 2.4G and 5.8G frequency bands that are using the LB protocol to transmit the signals, and it may take up to 12*112 milliseconds, that is, 1.34 seconds. Therefore, the signal acquisition time of 2 seconds may be satisfied.

In another example, in response to the signals satisfying the signal-to-noise ratio of the detection condition, when the monitored information is inserted into the beacon information and the beacon broadcast time slot of the UAV is 100 milliseconds, the Wi-Fi protocol parsing device may need to wait 100 milliseconds or more on each channel to complete the confirmation. Therefore, in theory, the parsing device 202 may only need to stay 100 milliseconds per channel to parse whether the current channel has the signals transmitted using the Wi-Fi protocol. In order to avoid the possibility of a false detection and certain synchronization failures in the case where the signal-to-noise ratio is not high, the parsing device 202 may spend 200 milliseconds per channel to parse whether the current channel has the signals transmitted using the Wi-Fi protocol. For UAVs using the Wi-Fi protocol, the 2.4G frequency band and the 5.8G frequency band may be used to transmit the signals of the UAVs, where the 2.4G frequency band may have 13 downlink channels and the 5.8G frequency band may have up to 9 downlink channels. In order to satisfy the signal acquisition time of 2 seconds, the signals in the 2.4G frequency band may correspond to 3 parsing devices 202, and the signals in the 5.8G frequency band may also correspond to 3 parsing devices 202. That is, the Wi-Fi protocol parsing device 202 may include 6 parsing devices, each of the parsing devices may correspond to one channel of signals, and the predetermined number of channels may be 6 as well.

Further, among the 3 parsing devices 202 corresponding to the 2.4G frequency band, the first parsing device 202 may parse the signals of 4 channels, the second parsing device 202 may parse the signals of 4 channels, and the third parsing device 202 may parse the signals of 5 channels.

Similarly, among the 3 parsing devices 202 corresponding to the 5.8G frequency band, the first parsing device 202 may parse the signals of 3 channels, the second parsing device 202 may parse the signals of 3 channels, and the third parsing device 202 may parse the signals of 3 channels.

Furthermore, the 6 parsing devices 202 may parse in parallel. Therefore, the 6 parsing devices 202 may parse all the downlink channels in the 2.4G and 5.8G frequency bands that are using the Wi-Fi protocol to transmit the signals, and it may take up to 5*200 milliseconds, that is, 1 second. Therefore, the signal acquisition time of 2 seconds may be satisfied.

In another example, the UAVs using the SDR protocol may select 4 fixed frequency points in the 2.4G frequency band to transmit the signals including the monitored information. Therefore, the SDR protocol parsing device 202 may have 4 parsing devices, each of the parsing devices may correspond to one channel of signals, and the predetermined number of channels may be 4 as well.

In some embodiments, as shown in FIG. 7, the signal process device may further include a signal pre-processing circuit 204. The antenna 201 may be connected to the power dividing component 203 via the signal pre-processing circuit 204. After the antenna 201 receives the signals including the monitored information transmitted by the UAV, the signal pre-processing circuit 204 may be used to separate the signals in the different frequency bands, respectively use different signal processing strategies to process signals in the different frequency bands, and synthesize the processed signals in the different frequency bands. Correspondingly, the plurality of communication protocol parsing devices may be specifically used to parse the synthesized signals to obtain the parsing results.

More specifically, the signal pre-processing circuit 204 may transmit the synthesized signals to the power dividing component 203. The synthesized signals may be divided into multiple channels by the power dividing component 203, and the plurality of communication protocol parsing devices 202 may parse the signals in the multiple channels to obtain the parsing results.

In some embodiments, the signal pre-processing circuit 204 may use different signal processing strategies to process the signals in the different frequency bands, respectively; and synthesize the processed signals in the different frequency bands. More specifically, the signal pre-processing circuit 204 may use different amplification strategies to amplify the signals in the different bands, and synthesize the signals in the different frequency bands after amplification. Alternatively, the signal pre-processing circuit 204 may separately process the signals in the different frequency bands by using different signal processing strategies, then synthesize the processed signals in the different frequency bands, which is not limited in the embodiments of the present disclosure.

In some embodiments, the signal pre-processing circuit 204 may include two or more multiplexers (e.g., duplexers) and a plurality of amplification circuits. The signal pre-processing circuit 204 may separate the signals in the different frequency bands using the multiplexer, use different amplification circuits to amplify the signals in the different frequency bands, and use the multiplexer to synthesize the amplified signals in the different frequency bands.

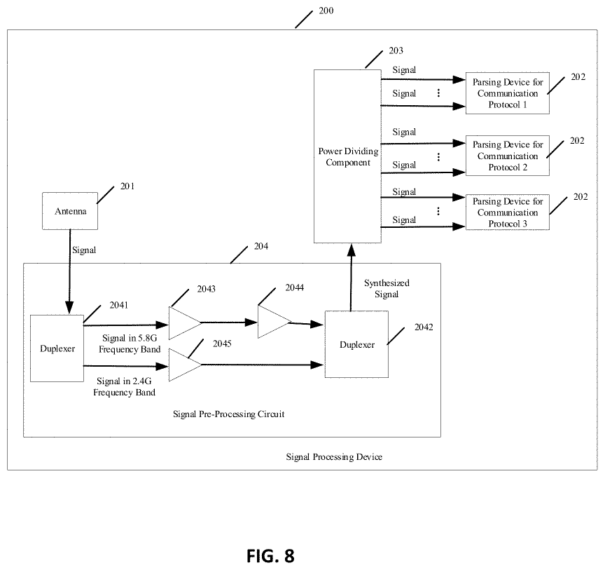

For example, as shown in FIG. 8, the signal pre-processing circuit may include a duplexer 2041, a duplexer 2042, a low noise amplifier 2043, a low noise amplifier 2044, and a low noise amplifier 2045. After the antenna 201 receives the signals in the 2.4G and 5.8G frequency bands, the antenna 201 may transmit a mixed signal of the 2.4G and 5.8G frequency bands to the duplexer 2041. The duplexer 2041 may separate the signals in the 2.4G frequency band from the signals in the 5.8G frequency band. In particular, the signals in the 5.8G frequency band may be amplified by the low noise amplifier 2043 and the low noise amplifier 2044, and the signals in the 2.4G frequency band may be amplified by the low noise amplifier 2045. That is, the signals in the 5.8G frequency band may be amplified twice and the signals in the 2.4G frequency band may be amplified once. The amplified signals in the 2.4G and 5.8G frequency bands may be directed to the duplexer 2042, and the duplexer 2042 may synthesize the amplified signals in the 2.4G and 5.8G frequency bands.

Further, after the duplexer 2042 may transmit the synthesized signal to the power dividing component 203 after synthesizing the amplified signals in the 2.4G and 5.8G frequency bands, the power dividing component 203 may divide the synthesized signal into multiple channels, and the plurality of communication protocol parsing devices 202 may parse the signals in the multiple channels to obtain the parsing results.

During the signal power division, the degree of signal attenuation in different frequency bands may be different. For example, the signal attenuation of the 2.4G frequency band may be different than the signal attenuation of the 5.8G frequency band. Generally, higher frequency may result in greater signal attenuation. In order to ensure the signal strength of the signals in the 5.8G frequency band it may be necessary to separate the signals transmitted by the UAV and separately process the 2.4G and 5.8G signals (for example, amplify the signals in the 5.8G frequency band twice and amplify the signals in the 2.4G frequency band once). Subsequently, the processed signals may be synthesized, and the synthesized signals may be subject to power division to ensure the signal strength of signals in the higher frequency band during the power division.

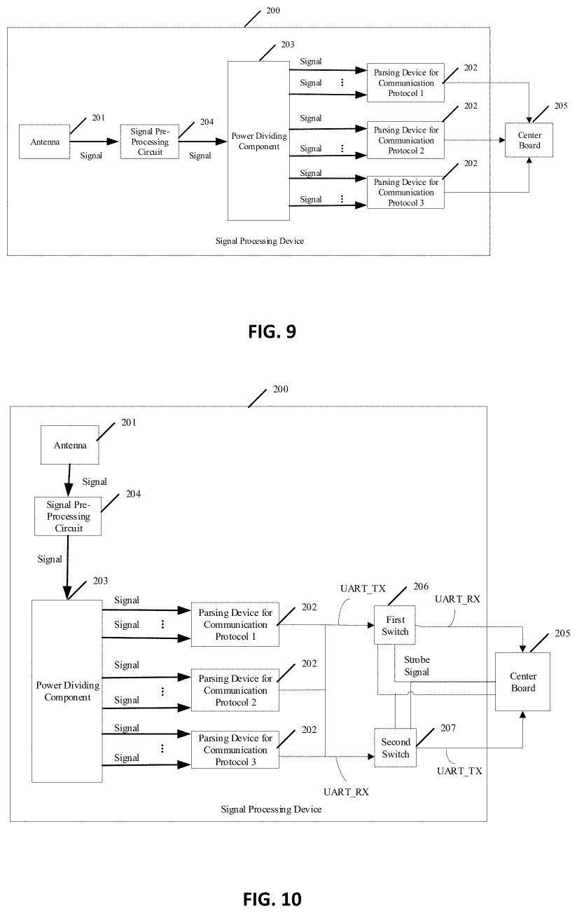

In some embodiments, as shown in FIG. 9, after the parsing device 202 obtains the parsing results by parsing the signals including the monitored information, the parsing device 202 may further transmit the parsing results to an external device. The external device may be a processor of the monitoring device or other devices with processing capability in the monitoring device. The external device is schematically illustrated as a center board including a processor below.

In some embodiments, after obtaining the parsing results, the center board 205 may obtain the monitored information of the UAV from one or more of the parsing results, then the parsing results may be transmitted to the external device using the 4G network, 5G, network, low frequency private network, or Ethernet.

In some embodiments, as shown in FIG. 10, the signal processing device 200 may further include a first switch 206 and a second switch 207, and each parsing device 202 may be connected to the center board 205 by the first switch 206 and the second switch 207. Further, the first switch 206 and the second switch 207 may also not be included in the signal processing device 200, and FIG. 10 is exemplified by the first switch 206 and the second switch 207 being included in the signal processing device 200.

More specifically, an output end of a communication interface of each type of communication protocol parsing device 202 may be connected to the first switch 206, and an input end the communication interface of each type of communication protocol parsing device 202 may be connected to the second switch 207. The output ends of the first switch 206 and the second switch 207 may be respectively connected to the input end and the output end of the communication interface of the center board 205. For example, if the total number of the plurality of communication protocol parsing devices 202 is 16, the first switch 206 and the second switch 207 may be a 16-1 switch. The center board 205 may be further used to perform a time-division strobing of the first switch 206 and the second switch 207 using a strobe signal to obtain the parsing results from the parsing devices 202. Further, the communication interface of the plurality of communication protocol parsing devices 202 and the communication interface of the center board 205 may use a UART protocol.

An embodiment of the present disclosure provides a monitoring device. The monitoring device may include of any one of the signal processing devices of the UAV mentioned above. The monitoring device may further include a processor, where the processor may be used to obtain a plurality of parsing results obtained by parsing the signals have the monitored information using the signal processing device.

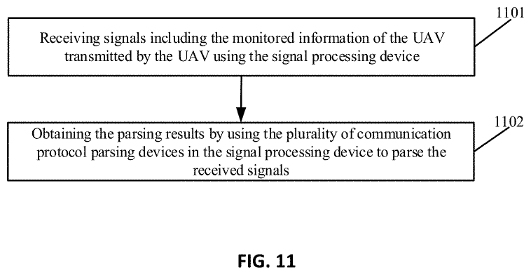

Referring to FIG. 11, which is a schematic flowchart of a signal processing method of a UAV according to an embodiment of the present disclosure. As shown in FIG. 11, the signal processing method may include the following steps:

Step 1101: receiving signals including the monitored information of the UAV transmitted by the UAV using the signal processing device.

Step 1102: obtaining the parsing results by using the plurality of communication protocol parsing devices in the signal processing device to parse the received signals.

In particular, the parsing results of one or more communication protocol parsing devices in the plurality of communication protocol parsing devices may include the monitored information of the UAV.

In the embodiments of the present disclosure, the specific implementation principle of the step 1101 may be the same as the antenna 201 in the foregoing device embodiments. For details, refer to the implementation principle of the antenna 201, which is not described herein.

In the embodiments of the present disclosure, the specific implementation principle of the step 1101 may be the same as the plurality of communication protocol parsing devices 202 in the foregoing device embodiments. For details, refer to the implementation principle of the plurality of communication protocol parsing devices 202, which is not described herein.

In some embodiments, the signal processing device may further divide the signals into multiple channels after receiving the signals including the monitored information of the UAV transmitted by the UAV. Correspondingly, obtaining the parsing results by using the plurality off communication protocol parsing devices in the signal processing device to parse the signals may include parsing the signals in the multiple channels using the plurality of communication protocol parsing devices in the signal processing device to obtain the parsing results.

In some embodiments, parsing the signals in the multiple channels using the plurality of communication protocol parsing devices in the signal processing device may include parsing a predetermined number channels of signals of the signals in the multiple channels using each of the communication protocol parsing device in the plurality of communication protocol parsing devices.

In some embodiments, each of the communication protocol parsing device in the plurality of communication protocol parsing devices may include a predetermined number of parsing devices. Correspondingly, parsing the predetermined number of channels of signals of the signals in the multiple channels using each of the communication protocol parsing device in the plurality of communication protocol parsing devices may include: parsing the predetermined number of channels of signals of the signals in the multiple channels using a predetermined number of parsing devices in each of the plurality of communication protocol parsing devices.

In some embodiments, after receiving the signals including the monitored information transmitted by the UAV, the signal processing device may further separate the signals in the different frequency bands from the signals and use different signal processing strategies to process the signals in the different frequency bands. Subsequently, the processed signals in the different frequency bands may be synthesized. Correspondingly, using the plurality of communication protocol parsing devices in the signal processing device to parse the signals to obtain the parsing results may include using the plurality of communication protocol parsing devices to parse the synthesized signals to obtain the parsing results.

In some embodiments, the signal processing device may use different signal processing strategies to process the signals in the different frequency bands, respectively; and synthesize the processed signals in the different frequency bands. More specifically, the signal processing device may use different amplification strategies to amplify the signals in the different bands and synthesize the signals in the different frequency bands after amplification.

In some embodiments, the signal processing device may transmit the parsing results to an external device.

In some embodiments, the predetermined number of channels and/or communication protocol parsing devices may be determined based on one or more of the following information: the number of downlink channels of the downlink data link of the UAV, an expected signal acquisition time, and the number of frequency points used by the UAV to transmit the signals including the monitored information.

In some embodiments, the various communication protocols may include two or more of the following communication protocols: ultra-wide band, Wi-Fi, Bluetooth, SDR, 802.11, Zigbee, and customized communication protocols.

In some embodiments, the monitored information of the UAV may include one or more of the location information of the UAV, the location information of the control terminal connected to the UAV, the ID number of the UAV, the takeoff location information of the UAV, and the flight speed of the UAV.

In particular, the implementation principle and the advantage of the method may be the same as the signal processing device mentioned in the foregoing device embodiments. For details, refer to the related description of the embodiments of the signal processing device, and details are not described herein.

A person skilled in the art should realize that in one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. An UAV signal processing method, comprising:
receiving a plurality of signals including monitored information of the UAV transmitted by the UAV; and,
parsing, by a plurality of communication protocol parsing devices, the received signals to obtain a plurality of parsing results, wherein one or more of the parsing results include the monitored information of the UAV.

2. The method of claim 1, further comprising:
dividing the signals into multiple channels; and,
parsing, by the plurality of communication protocol parsing devices, the signals in the multiple channels to obtain the parsing results.

3. The method of claim 2, further comprising:
parsing the signals in a predetermined number of channels of the multiple channels according to each type of communication protocol parsing device of the plurality of communication protocol parsing devices.

4. The method of claim 3, wherein:
each type of communication protocol parsing device includes a predetermined number of parsing devices; and
parsing the signals in the predetermined number of channels of the multiple channels according to each type of communication protocol parsing devices includes using the predetermined number of parsing devices of each type of the communication protocol parsing devices to parse the signals into the predetermined number of channels of the multiple channels.

5. The method of claim 1, wherein after receiving the signals including the monitored information of the UAV transmitted by the UAV further comprises:
separating the signals into different frequency bands;
processing the signals in the different frequency bands using different signal processing strategies; and
synthesizing the processed signals in the different frequency bands; and
wherein parsing, by the plurality of communication protocol parsing devices, the received signals to obtain the parsing results comprises parsing, by the plurality of communication protocol parsing devices, the synthesized signal to obtain the parsing results.

6. The method of claim 5, further comprising:
using different amplifying strategies to amplify the signals in the different frequency bands; and
synthesizing the amplified signals in the different frequency bands.

7. The method of claim 1, further comprising:
transmitting the parsing results to an external device.

8. The method of claim 3, wherein the predetermined number of channels and the predetermined number of parsing devices are determined based on one or more of the following:
the number of downlink channels of the UAV, an expected signal acquisition time, and
the number of frequency points used by the UAV to transmit the signals including the monitored information.

9. The method of claim 1, wherein the plurality of communication protocol includes two or more of the following: UWB, Wi-Fi, Bluetooth, 802.11, Zigbee, and a customized communication protocol.

10. The method of claim 1, wherein the monitored information includes one or more of the following: a location information of the UAV, a location information of a control terminal connected to the UAV, an identification number of the UAV, a location information of the UAV during takeoff, and a flight speed information of the UAV.

11. A signal processing device of an UAV, comprising:
an antenna configured to receive a plurality of signals including monitored information of the UAV transmitted by the UAV; and
a plurality of communication protocol parsing devices configured to parse the signals received by the antenna to obtain a plurality of parsing results, wherein one or more of the parsing results of the communication protocol parsing devices include the monitored information of the UAV.

12. The device of claim 11, further comprising:
a power dividing component configured to divide the signals received by the antenna into multiple channels, wherein the plurality of communication protocol parsing devices is configured to parse the signals in the multiple channels to obtain the parsing results.

13. The device of claim 12, wherein each type of communication protocol parsing device of the plurality of communication protocol parsing devices is configured to parse the signals in a predetermined channels of the multiple channels of signals.

14. The device of claim 13, wherein each type of communication protocol parsing device of the plurality of communication protocol parsing devices includes a predetermined number of parsing devices configured to parse the signals in a predetermined channels of the multiple channels of signals.

15. The device of claim 11, further comprising:
a signal processing circuit configured to separate the signals into different frequency bands after receiving the signals including the monitored information of the UAV transmitted by the UAV, to process the signals in the different frequency bands using different signal processing strategies, and to synthesize the processed signals in the different frequency bands, wherein the signal processing device is configured to parse the synthesized signal to obtain the parsing results.

16. The device of claim 15, wherein the signal processing device is configured to use different amplifying strategies to amplify the signals in the different frequency bands, and to synthesize the amplified signals in the different frequency bands.

17. The device of claim 11, wherein the plurality of communication protocol parsing devices is configured to transmit the parsing results to an external device.

18. The device of claim 13, wherein the predetermined number of channels and the predetermined number of parsing devices are determined based on one or more of the following: the number of downlink channels of the UAV, an expected signal acquisition time, and the number of frequency points used by the UAV to transmit the signals including the monitored information.

19. The device of claim 11, wherein the plurality of communication protocols includes two or more of the following: UWB, Wi-Fi, Bluetooth, 802.11, Zigbee, and a customized communication protocol.

20. The device of claim 11, wherein the monitored information includes one or more of the following: a location information of the UAV, a location information of a control terminal connected to the UAV, an identification number of the UAV, a location information of the UAV during takeoff, and a flight speed information of the UAV.
